(19) United States
(12) Patent Application Publication
(10) Pub. No.: US 2026/0149926 A1
(43) Pub. Date: May 28, 2026

(54) ADAPTIVE EARPHONE AND DETECTION SENSOR

(71) Applicant: LUXSHARE ELECTRONIC TECHNOLOGY (KUNSHAN) LTD., Kunshan City (CN)

(72) Inventors: Junlong LI, Kunshan City (CN); Cheng WANG, Kunshan City (CN)

(73) Assignee: LUXSHARE ELECTRONIC TECHNOLOGY (KUNSHAN) LTD., Kunshan City (CN)

(21) Appl. No.: 19/326,822

(22) Filed: Sep. 12, 2025

(30) Foreign Application Priority Data
Nov. 28, 2024 (CN) 202411729931.5

(51) Int. Cl. H04R 5/04; H04R 5/033; H04S 7/00

(52) U.S. Cl. CPC H04R 5/04; H04R 5/033; H04S 7/304; H04R 2205/024

(57) ABSTRACT

Provided are an adaptive earphone and a detection sensor. The adaptive earphone includes an earphone body, a controller, and a first detection sensor. The first detection sensor and the controller are disposed within the earphone body. The earphone body includes a first surface and a second surface which are disposed opposite to each other in a first direction. The first detection sensor is configured to detect an orientation of the first surface and an orientation of the second surface. The controller is electrically connected to the first detection sensor and is configured to control a channel output of the adaptive earphone according to the orientation of the first surface and the orientation of the second surface.

### CROSS-REFERENCE TO RELATED APPLICATION(S)

This application claims priority of a Chinese Patent Application filed with China National Intellectual Property Administration (CNIPA) on Nov. 28, 2024, with application No. 202411729931.5, the disclosure of which is incorporated herein by reference in its entirety.

### TECHNICAL FIELD

The present disclosure relates to the field of electronic technology, in particularly, an adaptive earphone and a detection sensor.

### BACKGROUND

In a wireless earphone or an open-back sport earphone, when the appearance design of the left earphone is the same as the appearance design of the right earphone, they may be placed randomly in the charging case and worn on either a left ear or a right ear randomly. However, when they are worn on either the left ear or the right ear randomly, to play a stereo audio source file, the left earpiece needs to play the left channel audio source while the right earpiece needs to play the right channel audio source. Therefore, it is necessary to make earphones adapt to the wearing manner on the left ear and the right ear automatically.

### SUMMARY

The present disclosure provides an adaptive earphone. The adaptive earphone includes an earphone body, a controller and a first detection sensor, the first detection sensor and the controller are disposed within the earphone body, and the earphone body includes a first surface and a second surface which are disposed opposite to each other in a first direction. The first detection sensor is configured to detect an orientation of the first surface and an orientation of the second surface. The controller is electrically connected to the first detection sensor and is configured to control a channel output of the adaptive earphone according to the orientation of the first surface and the orientation of the second surface.

The present disclosure further provides a detection sensor configured in an adaptive earphone, where the adaptive earphone comprises a first surface and a second surface which are disposed opposite to each other in a first direction. The detection sensor is configured to detect an orientation of the first surface and an orientation of the second surface, and the detection sensor is electrically connected to a controller of the adaptive earphone to enable the controller to control a channel output of the adaptive earphone according to the orientation of the first surface and the orientation of the second surface.

### BRIEF DESCRIPTION OF THE DRAWINGS

FIG. 1 is a schematic structural diagram of an adaptive earphone according to one or more embodiments of the present disclosure.

FIG. 2 is a schematic diagram of an electrical principle of a first detection sensor according to one or more embodiments of the present disclosure.

FIG. 3 is a schematic diagram of an electrical principle of a second detection sensor according to one or more embodiments of the present disclosure.

FIG. 4 is a schematic diagram of a tilting angle of a human body according to one or more embodiments of the present disclosure.

FIG. 5 is a schematic structural diagram of an adaptive earphone according to one or more embodiments of the present disclosure.

### DETAILED DESCRIPTION

In order that those skilled in the art will better understand solutions of the present disclosure, the technical solutions of embodiments of the present disclosure will be clearly and completely described below in conjunction with the drawings of the embodiments of the present disclosure. Apparently, the described embodiments are merely some embodiments of the present disclosure, rather than all of the embodiments. Based on the embodiments of the present disclosure, all other embodiments obtained by those of ordinary skill in the art without needing creative efforts shall fall in the scope of protection of the present disclosure.

It is to be noted that the terms "first", "second", and the like in the Description and claims of the present disclosure, and in the foregoing drawings, are used for distinguishing between similar objects and not necessarily for describing a particular order or sequential order. It is to be understood that the data so used are interchangeable as appropriate so that the embodiments of the present disclosure described herein can be implemented in an order other than those illustrated or described herein.

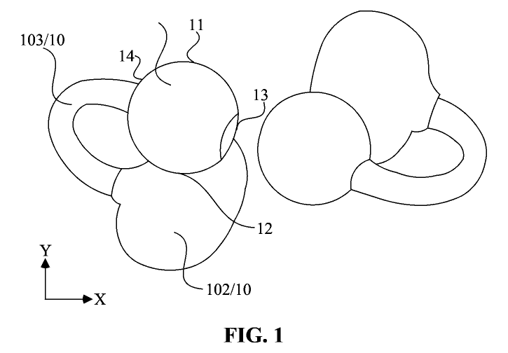

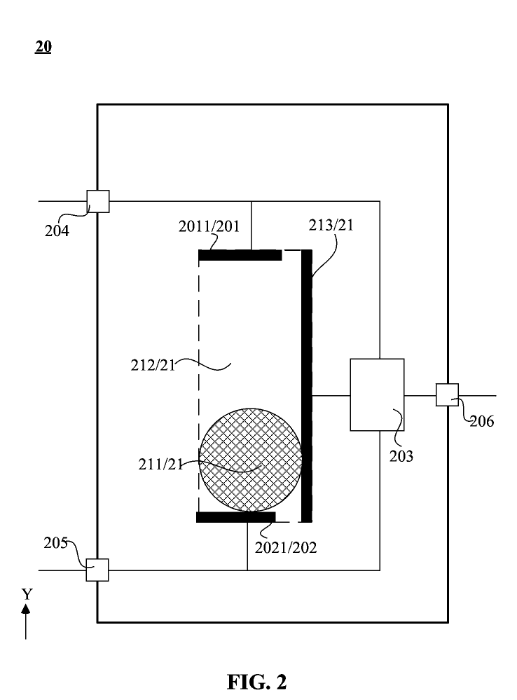

FIG. 1 is a schematic structural diagram of an adaptive earphone according to an embodiment of the present disclosure. FIG. 2 is a schematic diagram of an electrical principle of a first detection sensor according to an embodiment of the present disclosure. As shown in FIGS. 1 and 2, the adaptive earphone includes an earphone body 10, a controller 40 and a first detection sensor 20. The first detection sensor 20 and the controller 40 are disposed within the earphone body 10. The earphone body 10 includes a first surface 11 and a second surface 12 disposed opposite to each other in a first direction (Y direction shown in the drawings). The first detection sensor 20 is configured to detect an orientation of the first surface 11 and an orientation of the second surface 12. The controller 40 is electrically connected to the first detection sensor 20 and is configured to control a channel output of the adaptive earphone according to the orientation of the first surface 11 and the orientation of the second surface 12.

As a comparative embodiment, an ear-clip earphone in the related art has a left earphone and a right earphone. The left earphone steadily outputs a left channel, and the right earphone steadily outputs a right channel; therefore, a user generally needs to distinguish the left earphone from the right earphone before wearing them, that is, the left earphone is worn on the left ear and the right earphone is worn on the right ear; otherwise, the quality of the heard sound is affected, and further the experience effect of the user is affected.

The earphone body 10 of each earphone monomer includes a sound production segment 101, a fixed segment 102, and a connection segment 103 connecting the sound production segment 101 and the fixed segment 102. The connection segment 103 may be a flexible bracket so that the sound production segment 101 and the fixed segment 102 are located in front of and behind the ear of the user, respectively. In some embodiments, the bracket is made of a soft and skin-friendly silica gel material, to ensure comfort during wearing. The sound production segment 101 may be worn in front of the ears, and an acoustic module, such as a loudspeaker and a microphone, may be disposed in the sound production segment 101. The fixed segment 102 may be worn behind the ears, and a power supply module, a controller 40, a noise reduction module, a communication module and the like may be disposed in the fixed segment 102. Electronic elements inside the sound production segment 101 and the fixed segment 102 are not specifically limited in the embodiments of the present disclosure.

In some embodiments, the first detection sensor 20 may be disposed at the sound production segment 101. The sound production segment 101 includes the first surface 11 and the second surface 12 disposed opposite to each other in the first direction (Y direction). In this way, when the earphone is worn on the left ear, the first surface 11 faces upward and the second surface 12 faces downward; when the earphone is worn on the right ear, the first surface 11 faces downward and the second surface 12 faces upward. In the embodiments of the present disclosure, the first detection unit 20 is provided so that the orientation of the first surface 11 and the orientation of the second surface 12 may be detected. For example, when the first surface 11 faces upward and the second surface 12 faces downward, the first detection sensor 20 may output a level signal to the controller 40, and the controller 40 controls the speaker to output the left channel; when the first surface 11 faces downward and the second surface 12 faces upward, the first detection sensor 20 outputs another level signal to the controller 40, and the controller 40 controls the speaker to output the right channel; in this manner, the user does not need to distinguish wearing positions of the earphones before wearing, after the earphone is worn by the user, the earphone may adapt to the left ear and the right ear according to the wearing position of the user and then may output the corresponding channel, to improve the convenience of use and thus enhance the experience effect of the user.

In the adaptive earphone provided in the embodiments of the present disclosure, the first detection sensor is disposed in the earphone body, the first detection sensor can detect the orientations of the two surfaces, disposed opposite to each other, of the earphone body, that is, the orientation of the first surface and the orientation of the second surface, so that the wearing position of the earphone can be determined by detecting the orientations of the two surfaces disposed opposite to each other. Furthermore, the controller 40 is electrically connected to the first detection sensor 20, and the controller 40 can control the channel output of the adaptive earphone according to the orientation of the first surface and the orientation of the second surface, that is, the controller 40 can adjust the channel of the loudspeaker according to the wearing position of the earphone, so that the user does not need to distinguish the left channel from the right channel before wearing the earphone to achieve the left and right ear adaptation, thereby improving the convenience of using the earphone, and thus enhancing the experience effect of the user.

With continued reference to FIG. 2, the first detection sensor 20 includes a first detection surface 201 and a second detection surface 202 disposed opposite to each other in the first direction (Y direction). The first detection surface 201 is arranged to be parallel with the first surface 11, and the second detection surface 202 is arranged to be parallel with the second surface 12.

Further, with continued reference to FIGS. 1 and 2, the first detection surface 201 includes a first conductive segment 2011, and the second detection surface 202 includes a second conductive segment 2021. The first detection sensor 20 includes a first gravity unit 21, and the first gravity unit 21 includes a first conductive sliding block 211, a first empty cavity 212 extending in the first direction (Y direction), and a first fixed conductive block 213. The first conductive sliding block 211 is located within the first empty cavity 212 and is slidably connected to the first fixed conductive block 213. The first conductive sliding block 211 is configured to slide within the first empty cavity 212 in the first direction Y.

The first conductive sliding block 211 has a certain weight, and the first conductive sliding block 211 slides within the first empty cavity 212 when the earphone is worn by the user. Since the first conductive segment 2011, the second conductive segment 2021, the first conductive sliding block 211 and the first fixed conductive block 213 are all conductive, in this way, when the first detection surface 201 faces upward and the second detection surface 202 faces downward, that is, the first surface 11 faces upward and the second surface 12 faces downward, the first conductive sliding block 211, the second conductive segment 2021 and the first fixed conductive block 213 are electrically connected so that an output terminal of the first detection sensor 20 may output a level signal to the controller 40, and the controller 40 controls the speaker to output the left channel. When the first detection surface 201 faces downward and the second detection surface 202 faces upward, that is, the first surface 11 faces downward and the second surface 12 faces upward, the first conductive sliding block 211, the first conductive segment 2011 and the first fixed conductive block 213 are electrically connected, so that the output terminal of the first detection sensor 20 may output another level signal to the controller 40, and the controller 40 controls the speaker to output the right channel. Since the two level signals are different, the orientation of the first surface and the orientation of the second surface may be determined according to the output level signals, and further the first detection sensor may detect the orientations of the two surfaces disposed opposite to each other to achieve the left-right ear adaptation of the earphone.

It is to be noted that FIG. 2 only shows a technical solution in which the first conductive sliding block 211 is a conductive metal ball, and it is to be understood that the first conductive sliding block 211 may also be a conductive metal sliding block.

It is to be noted that the first conductive sliding block 211 is not fixed within the first empty cavity 212, but slides within the first empty cavity 212 due to its own gravity; therefore, the first conductive sliding block 211 cannot be fixedly electrically connected to the first fixed conductive block 213. However, when the first conductive sliding block 211 slides to the first conductive segment or the second conductive segment, the conductive segment, the conductive sliding block, and the fixed conductive block are electrically connected, and the first detection sensor has an output signal.

It is to be noted that the first detection sensor is provided so that the left-right ear adaptation of the earphone can be achieved when the human body is in normal upright or sitting postures.

With continued reference to FIG. 2, the first detection sensor 20 further includes a first level output unit 203. A first terminal of the first level output unit 203 is electrically connected to the first fixed conductive block 213, and the first level output unit 203 is configured to output a level signal according to a position of the first conductive sliding block 211.

In one or more embodiments, when the first conductive segment 2011 faces upward and the second conductive segment 2021 faces downward, the first conductive sliding block 211, the second conductive segment 2021 and the first fixed conductive block 213 are electrically connected so that the first level output unit 203 may output a high level signal. When the first conductive segment 2011 faces downward and the second conductive segment 2021 faces upward, the first conductive sliding block 211, the first conductive segment 2011 and the first fixed conductive block 213 are electrically connected so that the first level output unit 203 may output a low level signal.

In another embodiment, when the first conductive segment 2011 faces upward and the second conductive segment 2021 faces downward, the first conductive sliding block 211, the second conductive segment 2021 and the first fixed conductive block 213 are electrically connected so that the first level output unit 203 may output a low level signal. When the first conductive segment 2011 faces downward and the second conductive segment 2021 faces upward, the first conductive sliding block 211, the first conductive segment 2011 and the first fixed conductive block 213 are electrically connected so that the first level output unit 203 may output a high level signal.

In one or more embodiments, with continued reference to FIG. 2, the first detection sensor 20 further includes a first power supply terminal 204, a first ground terminal 205 and a first output terminal 206. The controller 40 is electrically connected to the first output terminal 206, and the controller 40 is configured to receive a level signal output by the first output terminal 206 and control the channel output of the adaptive earphone according to the level signal. The first conductive segment 2011 and a second terminal of the first level output unit 203 are electrically connected to the first power supply terminal 204, the second conductive segment 2021 and a third terminal of the first level output unit 203 are electrically connected to the first ground terminal 205, and the first output terminal 206 is also electrically connected to a fourth terminal of the first level output unit 203. Alternatively, the first conductive segment 2011 and a second terminal of the first level output unit 203 are electrically connected to the first ground terminal 205, the second conductive segment 2021 and a third terminal of the first level output unit 203 are electrically connected to the first power supply terminal, and the first output terminal 206 is electrically connected to a fourth terminal of the first level output unit 203.

An example in which when the first conductive sliding block 211, the first conductive segment 2011 and the first fixed conductive block 213 are electrically connected, the earphone is worn by the user on the right ear; when the first conductive sliding block 211, the second conductive segment 2021 and the first fixed conductive block 213 are electrically connected, the earphone is worn by the user on the left ear is used for description. In an embodiment, when the first conductive sliding block 211, the first conductive segment 2011 and the first fixed conductive block 213 are electrically connected, a low level may be output to the first level output unit 203, and the first level output unit 203 transmits the low level signal to the controller 40 through the first output terminal 206 so that the controller controls the speaker to output the right channel. When the first conductive sliding block 211, the second conductive segment 2021 and the first fixed conductive block 213 are electrically connected, a high level may be output to the first level output unit 203, and the first level output unit 203 transmits the high level signal to the controller 40 through the first output terminal 206 so that the controller 40 controls the speaker to output the left channel.

In another embodiment, when the first conductive sliding block 211, the first conductive segment 2011 and the first fixed conductive block 213 are electrically connected, a high level may be output to the first level output unit 203, and the first level output unit 203 transmits the high level signal to the controller 40 through the first output terminal 206, so that the controller 40 controls the speaker to output the right channel. When the first conductive sliding block 211, the second conductive segment 2021 and the first fixed conductive block 213 are electrically connected, a low level may be output to the first level output unit 203, and the first level output unit 203 transmits the low level signal to the controller 40 through the first output terminal 206, so that the controller 40 controls the speaker to output the left channel.

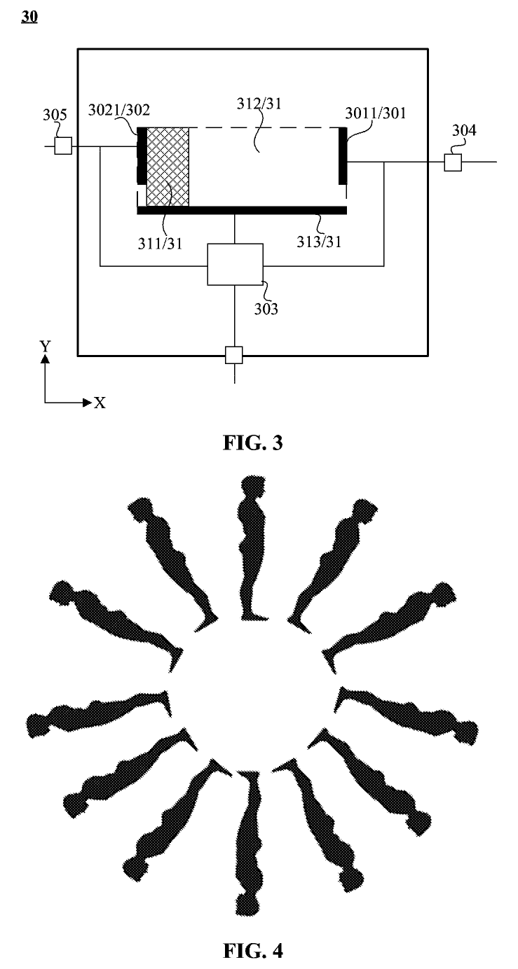

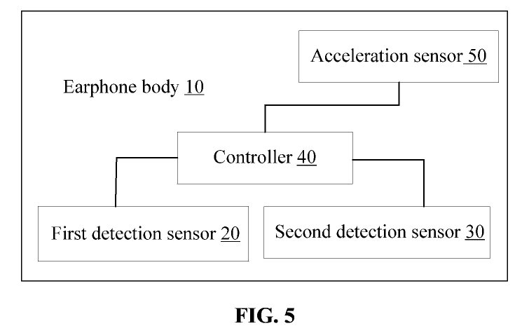

FIG. 3 is a schematic diagram of an electrical principle of a second detection sensor according to an embodiment of the present disclosure. As shown in FIGS. 1 and 3, the adaptive earphone further includes a second detection sensor 30. The earphone body 10 includes a third surface 13 and a fourth surface 14 disposed opposite to each other in a second direction (X direction shown in FIG. 1). The second direction (X direction) intersects the first direction (Y direction). The second detection sensor 30 includes a third detection surface 301 and a fourth detection surface 302 disposed opposite to each other in the second direction (X direction). The third detection surface 301 is arranged to be parallel with the third surface 13, and the fourth detection surface 302 is arranged to be parallel with the fourth surface 14. The second detection sensor 30 is configured to detect an orientation of the third surface 13 and an orientation of the fourth surface 14. The controller 40 is also electrically connected to the second detection sensor 30 and is configured to control the channel output of the adaptive earphone according to the orientation of the third surface 13 and the orientation of the fourth surface 14.

The connection line between the third surface 13 and the fourth surface 14 intersects the connection line between the first surface 11 and the second surface 12. The first detection sensor 20 may detect the orientation of the first surface 11 and the orientation of the second surface 12, and the second detection sensor 30 may detect the orientation of the third surface 13 and the orientation of the fourth surface 14, thereby achieving the left-right ear adaptation in all directions.

In some embodiments, when the user is in a state of lying on the side or tilting the head while wearing the earphone, the second detection sensor 30 is provided so that the orientation of the third surface 13 and the orientation of the fourth surface 14 can be detected. For example, when the user is in the state of lying on the side, in a case where the earphone is worn on the left ear, the fourth surface 14 faces upward and the third surface 13 faces downward, in this way, the second detection sensor 30 may output a level signal to the controller 40, and the controller 40 controls the speaker to output the left channel; and in a case where the earphone is worn on the right ear, the fourth surface 14 faces downward and the third surface 13 faces upward, in this way, the second detection sensor 30 may output another level signal to the controller 40, and the controller 40 controls the speaker to output the right channel; in this manner, the user does not need to distinguish the wearing position of the earphone before wearing the earphone, and after the earphone is worn by the user, the earphone can adapt to the left ear and the right ear according to the wearing position of the user and then output the corresponding channel, improving the convenience of use and enhancing the experience effect of the user.

In some embodiments, the first direction may be disposed perpendicular to the second direction.

In one or more embodiments, with continued reference to FIG. 3, the third detection surface 301 includes a third conductive segment 3011, and the fourth detection surface 302 includes a fourth conductive segment 3021. The second detection sensor 30 further includes a second gravity unit 31, and the second gravity unit 31 includes a second conductive sliding block 311, a second empty cavity 312 extending in the second direction (X direction), and a second fixed conductive block 313. The second conductive sliding block 311 is located within the second empty cavity 312 and is slidably connected to the second fixed conductive block 313. The second conductive sliding block 311 is configured to slide within the second empty cavity 312 in the second direction (X direction).

An example in which when the second conductive sliding block 311, the fourth conductive segment 3021 and the second fixed conductive block 313 are electrically connected, the earphone is worn by the user on the right ear; and when the second conductive sliding block 311, the third conductive segment 3011 and the second fixed conductive block 313 are electrically connected, the earphone is worn by the user on the left ear is used for description. The second conductive sliding block 311 has a certain weight; therefore, when the earphone is worn by the user and the user is in the state of lying on the side or tilting the head, the second conductive sliding block 311 may slide within the second empty cavity 312. Since the third conductive segment 3011, the fourth conductive segment 3021, the second conductive sliding block 311 and the second fixed conductive block 313 are all conductive, in this way, when the third conductive segment 3011 faces upward and the fourth conductive segment 3021 faces downward, that is, the third surface 13 faces upward and the fourth surface 14 faces downward, the second conductive sliding block 311, the fourth conductive segment 3021 and the second fixed conductive block 313 are electrically connected, so that an output terminal of the second detection sensor 30 may output a level signal to the controller 40, and the controller 40 controls the speaker to output the right channel. When the third conductive segment 3011 faces downward and the fourth conductive segment 3021 faces upward, that is, the third surface 13 faces downward and the fourth surface 14 faces upward, the second conductive sliding block 311, the third conductive segment 3011 and the second fixed conductive block 313 are electrically connected, so that the output terminal of the second detection sensor 30 may output another level signal to the controller 40, and the controller 40 controls the speaker to output the left channel. Since the two level signals are different, the orientation of the third surface and the orientation of the fourth surface may be determined according to the output level signals, and further the first detection sensor can detect the orientations of the two surfaces disposed opposite to each other to achieve the left-right ear adaptation of the earphone.

In some embodiments, the second conductive sliding block 311 may be a conductive metal sliding block or a conductive metal ball.

It is to be understood that the second detection sensor may further include a level output unit, a power supply terminal, a ground terminal, and an output terminal.

It is to be noted that the first detection sensor and the second detection sensor may be independently disposed or integrated together, that is, the first gravity unit and the second gravity unit are integrated into one sensor; in this manner, on the one hand, orientations of surfaces disposed opposite to each other in two directions in the earphone body can be detected, and on the other hand, the setting manner is simple.

In some embodiments, an example in which the adaptive earphone includes two detection sensors is used for description in the embodiments of the present disclosure, and it is to be understood that the adaptive earphone may further include a third detection sensor. FIG. 4 is a schematic diagram of a tilting angle of a human body according to an embodiment of the present disclosure. With continued reference to FIGS. 1 and 4, the third detection sensor may be configured to detect orientations of two oppositely disposed surfaces in a front-rear wearing direction parallel to the human body. The front-rear wearing direction of the human body may be understood as a direction from the front of the ear of the human body to the back of the ear of the human body. A normal upright state of the human body as 0° is used as an example for description, the third detection sensor only undergoes logical changes when the human body leans forward or lies back more than 90°. Similarly, when the human body tilts from the upright direction to the left-right direction, the third detection sensor only undergoes logical changes when the tilting angle of the human body exceeds 90°, so that the detection accuracy can be further ensured, and the self-adaptation in more application scenarios, such as lying down or nodding, can be achieved.

With continued reference to FIG. 3, the second detection sensor 30 further includes a second level output unit 303. A first terminal of the second level output unit 303 is electrically connected to the second fixed conductive block 313, and the second level output unit 303 is configured to output the level signal according to a position of the second conductive sliding block 311.

In one or more embodiments, when the third conductive segment 3011 faces upward and the fourth conductive segment 3021 faces downward, the second conductive sliding block 311, the fourth conductive segment 3021 and the second fixed conductive block 313 are electrically connected, so the second level output unit 303 may output a high level signal. When the third conductive segment 3011 faces downward and the fourth conductive segment 3021 faces upward, the second conductive sliding block 311, the third conductive segment 3011 and the second fixed conductive block 313 are electrically connected, so the second level output unit 303 may output a low level signal.

In another embodiment, when the third conductive segment 3011 faces upward and the fourth conductive segment 3021 faces downward, the second conductive sliding block 311, the fourth conductive segment 3021 and the second fixed conductive block 313 are electrically connected, so the second level output unit 303 may output a low level signal. When the third conductive segment 3011 faces downward and the fourth conductive segment 3021 faces upward, the second conductive sliding block 311, the third conductive segment 3011 and the second fixed conductive block 313 are electrically connected, so the second level output unit 303 may output a high level signal.

With continued reference to FIG. 3, the second detection sensor 30 further includes a second power supply terminal 304, a second ground terminal 305 and a second output terminal 306. The controller 40 is electrically connected to the second output terminal 306, and the controller 40 is configured to receive the level signal output by the second output terminal 306 and control the channel output of the adaptive earphone according to the level signal. The third conductive segment 3011 and a second terminal of the second level output unit 303 are electrically connected to the second power supply terminal 304, the fourth conductive segment 3021 and a third terminal of the second level output unit 303 are electrically connected to the second ground terminal 305, and the second output terminal 306 is also electrically connected to a fourth terminal of the second level output unit 303. Alternatively, the third conductive segment 3011 and a second terminal of the second level output unit 303 are electrically connected to the second ground terminal 305, the fourth conductive segment 3021 and a third terminal of the second level output unit 303 are electrically connected to the second power supply terminal 304, and the second output terminal 306 is electrically connected to a fourth terminal of the second level output unit 303.

An example in which when the second conductive sliding block 311, the third conductive segment 3011 and the second fixed conductive block 313 are electrically connected, the earphone is worn by the user on the right ear; and when the second conductive sliding block 311, the fourth conductive segment 3021 and the second fixed conductive block 313 are electrically connected, the earphone is worn by the user on the left ear is used for description. In an embodiment, when the second conductive sliding block 311, the third conductive segment 3011 and the second fixed conductive block 313 are electrically connected, the low level may be output to the second level output unit 303, and the second level output unit 303 transmits the low level signal to the controller 40 through the second output terminal 306, so the controller 40 controls the speaker to output the right channel. When the second conductive sliding block 311, the fourth conductive segment 3021 and the second fixed conductive block 313 are electrically connected, the high level may be output to the second level output unit 303, and the second level output unit 303 transmits the high level signal to the controller 40 through the second output terminal 306, so the controller 40 controls the speaker to output the left channel.

In another embodiment, when the second conductive sliding block 311, the third conductive segment 3011 and the second fixed conductive block 313 are electrically connected, the high level may be output to the second level output unit 303, and the second level output unit 303 transmits the high level signal to the controller 40 through the second output terminal 306, so the controller 40 controls the speaker to output the right channel. When the second conductive sliding block 311, the fourth conductive segment 3021 and the second fixed conductive block 313 are electrically connected, the low level may be output to the second level output unit 303, and the second level output unit 303 transmits the low level signal to the controller 40 through the second output terminal 306, so the controller 40 controls the speaker to output the left channel.

It is to be understood that the first power supply terminal and the second power supply terminal may be the same power supply terminal, and the first ground terminal and the second ground terminal may be the same ground terminal.

With continued reference to FIG. 2, in the first direction (Y direction), an extension length of the first fixed conductive block 213 is greater than or equal to a spacing between the first detection surface 201 and the second detection surface 202.

In the first direction (Y direction), the extension length of the first fixed conductive block 213 is greater than or equal to the spacing between the first detection surface 201 and the second detection surface 202 so that when the first conductive sliding block 211 slides within the first empty cavity 212, the electrical connection effect between the first conductive segment 2011, the first conductive sliding block 211 and the first fixed conductive block 213, or the electrical connection effect between the second conductive segment 2021, the first conductive sliding block 211 and the first fixed conductive block 213 can be ensured, thereby ensuring the stability and reliability of the first detection sensor.

In one or more embodiments, the adaptive earphone further includes an acceleration sensor 50. The controller 40 is electrically connected to the acceleration sensor 50 and is configured to control the channel output of the adaptive earphone according to a sensing signal of the acceleration sensor 50.

In one or more embodiments, an acceleration sensor 50 may be disposed inside the earphone body and is configured to sense a head motion of the user. When the acceleration value detected by the acceleration sensor 50 is 0, it indicates that the current state of the user is a stationary state, and in this case, the posture of the user is interpreted to prevent the earphone from shaking and thus misjudging the displacement of the first conductive sliding block or the second conductive sliding block when the user moves. Three-dimensional coordinates may be detected by the acceleration sensor 50 so that the left-right channel adaptation of the user in any free posture can be completed, and the self-adaptation of the earphone can be further ensured.

With continued reference to FIG. 2, the first conductive sliding block 211 includes a first conductive sphere or a first conductive rectangular block, that is, the shape of the first conductive sliding block 211 may be circular or rectangular, so that the diversified settings of the first detection sensor can be achieved.

In one or more embodiments, the first conductive sliding block 211 includes a first conductive rectangular block. The shape of the first conductive sliding block 211 is set as a cube so that a contact area between the first conductive sliding block 211 and the first conductive segment 2011, a contact area between the first conductive sliding block 211 and the second conductive segment 2021, and a contact area between the first conductive sliding block 211 and the first fixed conductive block 213 can be increased, thereby being conducive to ensuring the conductive effect, and further improving the stability of the sensor.

In one or more embodiments, the first conductive sliding block 211 includes a first conductive sphere, and the shape of the first conductive sliding block 211 is set as a sphere, so that it is beneficial for the first conductive sliding block 211 to slide within the first empty cavity 212, thereby improving the detection accuracy of the sensor.

With continued reference to FIG. 2, the first level output unit 203 includes a metal oxide semiconductor field effect transistor so that when the first conductive sliding block 211 slides within the first empty cavity 212, the first level output unit 203 outputs the level signal to a control terminal of the metal oxide semiconductor field effect transistor; thus controlling the metal oxide semiconductor field effect transistor to be turned on and off, whereby the orientations of two surfaces disposed opposite to each other in the first direction can be detected according to the on and off of the metal oxide semiconductor field effect transistor.

In some embodiments, the first level output unit 203 may also be composed of a resistor and two triodes. In one or more embodiments, one terminal of the resistor is electrically connected to the first fixed conductive block, and the other terminal of the resistor is electrically connected to the two transistors, separately.

It is to be noted that in the process of the user wearing the earphone, since the motion or the shaking may occur to a certain degree, a situation in which an output signal of the sensor is incorrect, the optimization may be performed on the algorithm to remove an event with a small probability. In some embodiments, the output signal of the sensor may be counted for a certain time and recorded, for example, statistics are collected continuously at a rate of 100 times per second for a duration of 10 seconds. Due to the effect of gravity, a situation in which the occurrence probability of the signal is greater than 70% may be defined as the conductive sliding block being downward; when the occurrence probability of the signal is between 30% and 70%, no determination needs to be made; and a situation in which the occurrence probability of the signal is less than 30% may be defined as the conductive sliding block being upward (The specific proportions may be counted according to actual situations).

In summary, according to the technical solutions provided in the embodiments of the present disclosure, the first detection sensor is disposed in the earphone body, the first detection sensor can detect the orientations of the two surfaces, disposed opposite to each other, of the earphone body, that is, the orientation of the first surface and the orientation of the second surface, so that the wearing position of the earphone can be determined by detecting the orientations of the two surfaces disposed opposite to each other. Furthermore, the controller is electrically connected to the first detection sensor, and the controller can control the channel output of the adaptive earphone according to the orientation of the first surface and the orientation of the second surface, that is, the controller can adjust the channel of the loudspeaker according to the wearing position of the earphone, so that the user does not need to distinguish the left channel from the right channel before wearing the earphone, thereby improving the convenience of using the earphone, and thus enhancing the experience effect of the user.

It is to be noted that the above contents are merely embodiments of the present disclosure and the technical principles applied herein. It is to be understood by those skilled in the art that the present disclosure is not limited to the particular embodiments described herein. For those skilled in the art, various apparent modifications, adaptations, combinations and substitutions may be made without departing from the scope of protection of the present disclosure. Therefore, although the present disclosure has been described in detail through the above embodiments, the present disclosure is not limited to the above embodiments and may include some other equivalent embodiments without departing from the concept of the present disclosure. The scope of the present disclosure is determined by the scope of the appended claims.

What is claimed is:

1. An adaptive earphone, comprising an earphone body, a controller and a first detection sensor, wherein the first detection sensor and the controller are disposed within the earphone body, and the earphone body comprises a first surface and a second surface which are disposed opposite to each other in a first direction;
the first detection sensor is configured to detect an orientation of the first surface and an orientation of the second surface; and
the controller is electrically connected to the first detection sensor and is configured to control a channel output of the adaptive earphone according to the orientation of the first surface and the orientation of the second surface.

2. The adaptive earphone of claim 1, wherein the first detection sensor comprises a first detection surface and a second detection surface which are disposed opposite to each other in the first direction; and
the first detection surface is arranged to be parallel with the first surface, and the second detection surface is arranged to be parallel with the second surface.

3. The adaptive earphone of claim 2, wherein the first detection surface comprises a first conductive segment, and the second detection surface comprises a second conductive segment; and
the first detection sensor comprises a first gravity unit, the first gravity unit comprises a first conductive sliding block, a first empty cavity extending in the first direction, and a first fixed conductive block, the first conductive sliding block is located within the first empty cavity and is slidably connected to the first fixed conductive block, and the first conductive sliding block is configured to slide within the first empty cavity in the first direction.

4. The adaptive earphone of claim 3, wherein the first detection sensor further comprises a first level output unit; and
a first terminal of the first level output unit is electrically connected to the first fixed conductive block, and the first level output unit is configured to output a level signal according to a position of the first conductive sliding block.

5. The adaptive earphone of claim 4, wherein the first detection sensor further comprises a first power supply terminal, a first ground terminal and a first output terminal;
the controller is electrically connected to the first output terminal and is configured to receive a level signal output by the first output terminal and control the channel output of the adaptive earphone according to the level signal; and
the first conductive segment and a second terminal of the first level output unit are electrically connected to the first power supply terminal, the second conductive segment and a third terminal of the first level output unit are electrically connected to the first ground terminal, and the first output terminal is further electrically connected to a fourth terminal of the first level output unit; or, the first conductive segment and a second terminal of the first level output unit are electrically connected to the first ground terminal, the second conductive segment and a third terminal of the first level output unit are electrically connected to the first power supply terminal, and the first output terminal is further electrically connected to a fourth terminal of the first level output unit.

6. The adaptive earphone of claim 1, further comprising a second detection sensor; wherein
the earphone body comprises a third surface and a fourth surface which are disposed opposite to each other in a second direction, wherein the second direction intersects the first direction;
the second detection sensor comprises a third detection surface and a fourth detection surface which are disposed opposite to each other in the second direction;
the third detection surface is arranged to be parallel with the third surface, and the fourth detection surface is arranged to be parallel with the fourth surface; and
the second detection sensor is configured to detect an orientation of the third surface and an orientation of the fourth surface, and the controller is further electrically connected to the second detection sensor and is configured to control the channel output of the adaptive earphone according to the orientation of the third surface and the orientation of the fourth surface.

7. The adaptive earphone of claim 6, wherein the third detection surface comprises a third conductive segment, and the fourth detection surface comprises a fourth conductive segment; and
the second detection sensor further comprises a second gravity unit, the second gravity unit comprises a second conductive sliding block, a second empty cavity extending in the second direction, and a second fixed conductive block, the second conductive sliding block is located within the second empty cavity and is slidably connected to the second fixed conductive block, and the second conductive sliding block is configured to slide within the second empty cavity in the second direction.

8. The adaptive earphone of claim 7, wherein the second detection sensor further comprises a second level output unit; and
a first terminal of the second level output unit is electrically connected to the second fixed conductive block, and the second level output unit is configured to output a level signal according to a position of the second conductive sliding block.

9. The adaptive earphone of claim 8, wherein the second detection sensor further comprises a second power supply terminal, a second ground terminal and a second output terminal;
the controller is electrically connected to the second output terminal and is configured to receive a level signal output by the second output terminal and control the channel output of the adaptive earphone according to the level signal; and
the third conductive segment and a second terminal of the second level output unit are electrically connected to the second power supply terminal, the fourth conductive segment and a third terminal of the second level output unit are electrically connected to the second ground terminal, and the second output terminal is further electrically connected to a fourth terminal of the second level output unit; or, the third conductive segment and a second terminal of the second level output unit are electrically connected to the second ground terminal, the fourth conductive segment and a third terminal of the second level output unit are electrically connected to the second power supply terminal, and the second output terminal is also electrically connected to a fourth terminal of the second level output unit.

10. The adaptive earphone of claim 3, wherein in the first direction, an extension length of the first fixed conductive block is greater than or equal to a spacing between the first detection surface and the second detection surface.

11. The adaptive earphone of claim 1, further comprising an acceleration sensor, wherein
the controller is electrically connected to the acceleration sensor and is configured to control the channel output of the adaptive earphone according to a sensing signal of the acceleration sensor.

12. The adaptive earphone of claim 4, wherein the first level output unit comprises a metal oxide semiconductor field effect transistor.

13. The adaptive earphone of claim 8, wherein the second level output unit comprises a metal oxide semiconductor field effect transistor.

14. A detection sensor, being configured in an adaptive earphone, wherein the adaptive earphone comprises a first surface and a second surface which are disposed opposite to each other in a first direction,
wherein the detection sensor is configured to detect an orientation of the first surface and an orientation of the second surface; and the detection sensor is electrically connected to a controller of the adaptive earphone to enable the controller to control a channel output of the adaptive earphone according to the orientation of the first surface and the orientation of the second surface.

15. The detection sensor of claim 14, wherein the detection sensor comprises a first detection surface and a second detection surface which are disposed opposite to each other in the first direction; and
the first detection surface is arranged to be parallel with the first surface, and the second detection surface is arranged to be parallel with the second surface.

16. The detection sensor of claim 15, wherein the first detection surface comprises a first conductive segment, and the second detection surface comprises a second conductive segment; and
the detection sensor comprises a first gravity unit, the first gravity unit comprises a first conductive sliding block, a first empty cavity extending in the first direction, and a first fixed conductive block, the first conductive sliding block is located within the first empty cavity and is slidably connected to the first fixed conductive block, and the first conductive sliding block is configured to slide within the first empty cavity in the first direction.

17. The detection sensor of claim 16, wherein the detection sensor further comprises a first level output unit; and a first terminal of the first level output unit is electrically connected to the first fixed conductive block, and the first level output unit is configured to output a level signal according to a position of the first conductive sliding block.

18. The detection sensor of claim 17, wherein the detection sensor further comprises a first power supply terminal, a first ground terminal and a first output terminal;
the controller is electrically connected to the first output terminal and is configured to receive a level signal output by the first output terminal and control the channel output of the adaptive earphone according to the level signal; and
the first conductive segment and a second terminal of the first level output unit are electrically connected to the first power supply terminal, the second conductive segment and a third terminal of the first level output unit are electrically connected to the first ground terminal, and the first output terminal is further electrically connected to a fourth terminal of the first level output unit; or, the first conductive segment and a second terminal of the first level output unit are electrically connected to the first ground terminal, the second conductive segment and a third terminal of the first level output unit are electrically connected to the first power supply terminal, and the first output terminal is further electrically connected to a fourth terminal of the first level output unit.

19. The detection sensor of claim 17, wherein the first level output unit comprises a metal oxide semiconductor field effect transistor.

20. The detection sensor of claim 14, wherein a plurality of detection sensors are provided in the adaptive earphone, the adaptive earphone further comprises a third surface and a fourth surface which are disposed opposite to each other in a second direction, wherein the second direction intersects the first direction; and
the plurality of detection sensors are further configured to detect an orientation of the third surface and an orientation of the fourth surface.
